(19) United States
(12) Patent Application Publication
(10) Pub. No.: US 2002/0015772 A1
(43) Pub. Date: Feb. 7, 2002

(54) ESSENCE RECOVERY SYSTEM

(76) Inventors: JIM MUNCH, KENT, WA (US); JAMES B. CARLSON, NORTH TONAWANDA, NY (US)

Correspondence Address: KARLA M WEYAND, NIXON HARGRAVE DEVANS & DOYLE, CLINTON SQUARE, PO BOX 1051, ROCHESTER, NY, 14603

(21) Appl. No.: 09/062,953

(22) Filed: Apr. 20, 1998

Related U.S. Application Data
(60) Provisional application No. 60/045,014, filed on Apr. 28, 1997.

(51) Int. Cl. A23L 1/00; A23L 1/185

(52) U.S. Cl. 426/478; 426/16

(57) ABSTRACT

The present invention relates to a method of recovering essence from a mash. The method includes providing a mash which includes essence, treating the mash to produce a vapor stream and a mash stream, where the vapor stream includes the essence, and condensing the vapor stream which includes the essence under conditions effective to recover the essence. The present invention further relates to an essence recovery system.

### FIELD OF THE INVENTION

This invention relates to a method and apparatus for recovering essence from a mash.

### BACKGROUND OF THE INVENTION

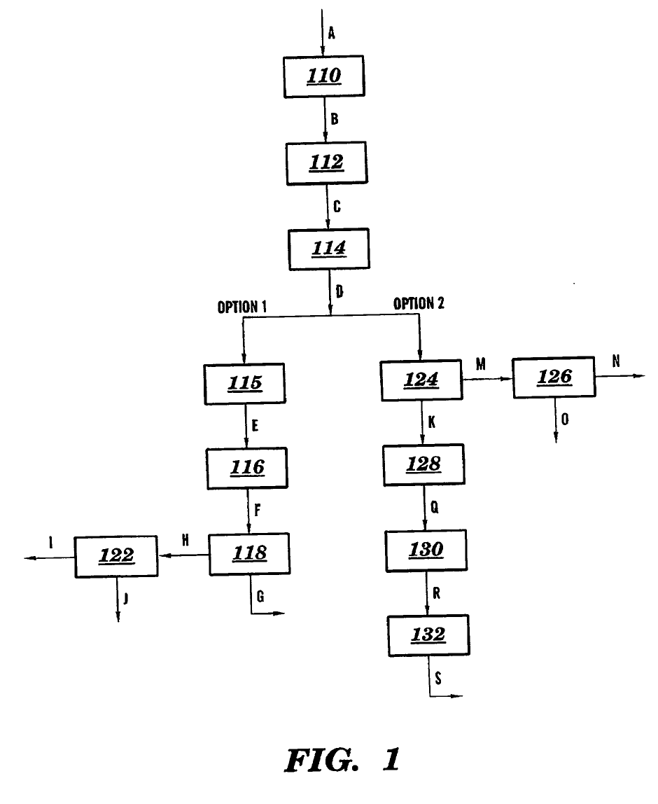

A schematic of a typical fruit juice processing line is shown in FIG. 1. The processing conditions may vary slightly, depending on the type of fruit product. Typically, the process includes providing a whole fruit A to a chopper 110. Whole fruit A is milled in chopper 110 to produce a mash B. Mash B is heated in a heat exchange treatment device 112 to product hot mash C. Optionally, enzyme is added to hot mash C to break down the fruit cells. Next, hot mash C is pressed in a press 114, to produce a juice D.

As shown in FIG. 1, in Option 1, Juice D is depectinized in a depectinization tank 115 to produce a depectinized juice E. Depectinized juice E can be filtered, if desired, in filter 116 to produce a filtered juice F. Filtered juice F is concentrated, typically in an evaporator 118, to produce a concentrated juice G. Water vapor H from evaporator 120 is sent to an essence recovery system 122 to produce a essence stream I and a condensate stream J.

Alternatively, as shown in Option 2, Juice D undergoes a stripping step in a stripping evaporator 124 to produce a juice stream K and a vapor stream M. Vapor stream M is treated in an essence recovery system 126 to produce an essence stream N and a condensate stream O. Juice stream K is then depectinized in depectinization tanks 128, to produce a depectinized juice Q, which is filtered, if desired, in a filter 130, to produce a filtered juice R. Filtered juice R is then concentrated, for example, by evaporation in evaporator 132 to produce a concentrated juice S.

Concentrated juice streams S or G are then sent for further processing downstream. Essence streams I and N are added back to concentrated juice streams G and S to return the flavor to the juice.

Fruit juices owe their aroma and much of their flavor to organic compounds known generally as essences. Accordingly, the essence is an extremely valuable component of the juice; without it the juice would lack its characteristic flavor and aroma. Generally, the essences are very volatile compounds, such as (depending on the type of juice) alcohols, including methyl alcohol, esters, carbonyls, and aldehydes. Thus, during the processing operation to produce juice from fruit, the essences readily escape to the atmosphere, reducing the quality of the juice. In addition, the essence is subject to oxidation, heat degradation, and chemical decomposition during prolonged storage. Thus, it is desirable to recover the essence from the fruit as soon as possible in the process. Further, when fruit juice is concentrated by removing the water vapor in an evaporator, many of the volatile components, which include the essences, are removed with the water vapor. Unless the essences can be recovered and made available for blending back into the concentrated juice in the correct proportion, the juice when reconstituted will lack the characteristic flavor of the original; as a result, the product will be inferior and sometimes even unacceptable.

Various types of essence recovery systems have been used to recover this essence and are described in U.S. Pat. No. 4,561,941 to Dinnage et al. Typically, the essence recovery systems are of two types.

One type of essence recovery system (as shown in Option 1) is used in conjunction with a concentrating type evaporator. During concentration of the juice, the volatile components which are mixed with the water vapor on evaporation are recovered by condensing the water vapor and distilling the resulting essence rich condensate to produce the essence. As shown in FIG. 1, the juice undergoes complete processing prior to the recovery of the essence in this type of arrangement.

Alternatively, the essence recovery system is utilized after the pressing operation (as shown in Option 2). In this system, the juice is fed through a “stripping” evaporator, which is designed to merely “strip” the water vapor containing the essence from the juice, with minimal concentration of the juice. Typically, about 15 to 50% of the water of the feed juice is evaporated, depending on type of juice, which is sufficient to remove the majority of the essences from the juice. The evaporated water vapor is then condensed and distilled to recover the essence. In this type of design, much of the energy utilized in the stripping evaporator is lost, making this design relatively energy inefficient.

Further, in both types of these essence recovery systems, the essence is subjected to significant heat treatment and holding time at elevated temperatures prior to its recovery. Thus, the essence becomes degraded. Further, the essence, being a volatile component, will necessarily escape into the atmosphere during processing in open tanks, such as during depectinization. As a consequence, a less desirable quality essence is obtained. Lastly, because these types of essence recovery systems are located after the pressing operation, they recover the essence components from the juice only, without recovering the valuable essences contained in the other components of the fruit, such as the peel.

The present invention is directed to overcoming these deficiencies.

### SUMMARY OF THE INVENTION

The present invention relates to a method of recovering essence from a mash. The method includes providing a mash which includes essence, treating the mash to produce a vapor stream and a mash stream, where the vapor stream includes the essence, and condensing the vapor stream which includes the essence under conditions effective to recover the essence.

Another aspect of the invention relates to essence recovery system for recovering essence from a mash which includes essence. The system includes a means for treating the mash to produce a vapor stream and a mash stream, where the vapor stream includes the essence and a condenser for condensing the vapor stream under conditions effective to recover the essence.

The present invention allows for the recovery of high quality essence from a mash, because the essence has not undergone the number of processing steps typical in other methods. Thus, the essence has not been subject to extensive heat treatments and long residence times, which degrade the quality of the essence. Additionally, the present invention allows the essence to be recovered from the entire fruit, including the peel. Further, the present invention can be utilized by manufacturers who do not wish to concentrate their product. In addition, once the essence is removed from the product, downstream processing temperatures are less critical, allowing greater flexibility in equipment design.

### DETAILED DESCRIPTION OF THE DRAWINGS

FIG. 1 illustrates a schematic of two typical fruit juice process lines.

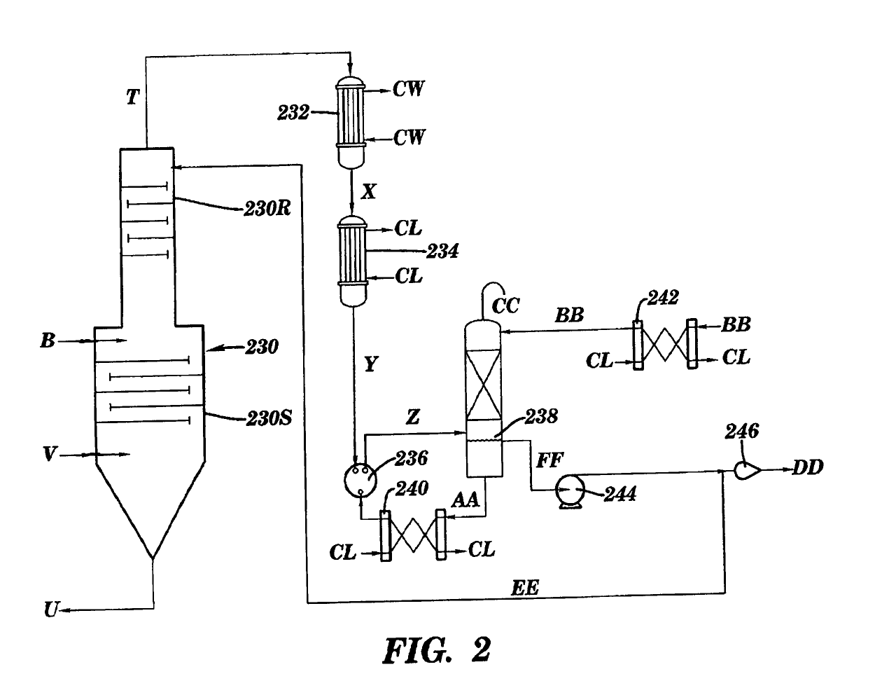

FIG. 2 illustrates one embodiment of the present invention.

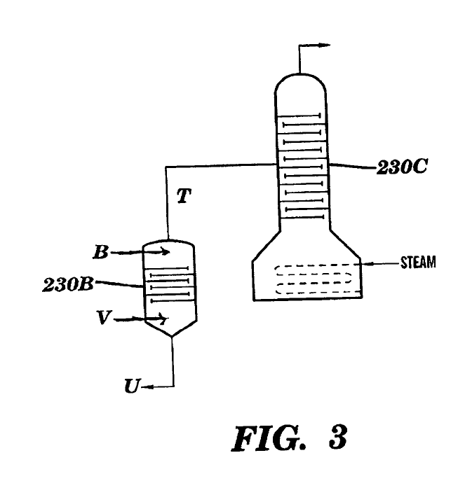

FIG. 3 illustrates a second embodiment of the present invention.

### DETAILED DESCRIPTION OF THE INVENTION

The present invention relates to a method of recovering essence from a mash. The method includes providing a mash which includes essence, treating the mash to produce a vapor stream and a mash stream, where the vapor stream includes the essence, and condensing the vapor stream which includes the essence under conditions effective to recover the essence.

Another aspect of the invention relates to essence recovery system for recovering essence from a mash which includes essence. The system includes a means for treating the mash to produce a vapor stream and a mash stream, where the vapor stream includes the essence and a condenser for condensing the vapor stream under conditions effective to recover the essence.

As used herein, the term “mash” relates to a product which includes essence, where the product has been milled to coarsely chop the product into pieces. Although the mash may be generally solid at room temperature, on heating, the mash typically consists of a mixture of a solid phase and a liquid phase, where the liquid phase may be vaporized.

Although the present invention is described using a fruit juice processing line as an example, it is understood that the present invention can be used to recover the essence of any product containing essences. For example, the present invention can be used to recover the essences of vegetables, such as carrots, beets, onions, and tomatoes, as well as fruits such as apples, pears, oranges, berries, grapes, peaches, plums, and currants, to name but a few.

In the method of the present invention, a mash B which includes essence is provided. Preferably, mash B is produced by milling, for example, a fruit. In addition, desirably, mash B has been heated. Importantly, mash B has not undergone pressing to produce a juice. Subsequently, mash B is treated to produce a vapor stream T and a mash stream U, where vapor stream T includes the essence. Vapor stream T is then condensed under conditions effective to recover the essence. Mash B can be treated under any conditions effective to produce vapor stream T and mash stream U. For example, mash B can be subjected to a heat treatment so that a portion of the liquid component of mash B is vaporized from mash B to produce vapor stream T and mash stream U.

One embodiment of the present invention is depicted in FIG. 2. Preferably, the treating step is achieved by flashing mash B to produce vapor stream T and mash stream U. Desirably, the flashing occurs by providing mash B to vessel 230 at a temperature of from about 40° to about 100° C., with from about 85° to 100° C. being especially preferred. Vessel 230 is under vacuum conditions, with a vacuum of from about 20″ Hg to about 28″ Hg being preferred. Vacuum conditions in vessel 230 are produced by vacuum pump 236, which also operates to drive vapor stream T through the subsequent process phases. Mash B, when subjected to the vacuum conditions in vessel 230, will flash to a temperature of from about 37° to about 71° C., thereby releasing a corresponding volume of water vapor. Because the essence is highly volatile, on flashing, the vast majority of essence will be contained in vapor stream T.

Typically, vapor stream T is condensed to recover the essence. Preferably, the condensing includes cooling vapor stream T to produce a cooled condensate stream Y having a temperature of from about 0.5° C. to about 10° C. to recover the essence. More preferably, the essence is condensed in two steps to recover the essence. In particular, vapor stream T is cooled in a first cooling step to produce mixture stream X having a temperature from about 32° C. to about 34° C., where mixture stream X includes a mixture of condensate and vapor. This step typically takes place in a first condenser 232, such as a shell and tube type condenser or a plate-type condenser. Cooling water (CW), or any other desirable cooling liquid, is provided to condenser 232 to condense and cool the vapor stream. Next, mixture stream X is additionally cooled to a temperature from about 0.5° C. to about 10° C. in a second condenser 234 to cool and further condense mixture stream X to produce cooled condensate Y. Typically a cooling liquid (CL), such as refrigerated glycol, is used in second condenser 234.

Additionally, research has shown that significant essence is contained in a portion of the vapor stream that is most difficult to condense, i.e. the “noncondensibles”. Thus, cooled condensate stream Y may still include a portion of vapor. Accordingly, it is desirable to include a scrubber system to recover the essence contained in the noncondensibles portion (i.e. vapor) of cooled condensate Y. The scrubber system includes a liquid ring vacuum pump 236 that has a vapor separator 238 on its discharge, two heat exchangers 240 and 242, a reflux pump 244, and a flow regulator 246.

The essence rich vapor and condensate contained in cooled condensate Y is drawn into the suction side of vacuum pump 236 from condenser 234, where it is compressed from a vacuum to atmospheric pressure. Alternatively, if desired, the condensate portion of cooled condensate Y can be returned to vessel 230a for further processing (as discussed below) and only the vapor component of cooled condensate Y is drawn into vacuum pump 36. Typically, the condensate portion of cooled condensate Y is mixed with reflux stream EE prior to flow regulation 246. In either case, as the pressure is raised on cooled condensate Y in vacuum pump 236, a major portion of the essence components contained in the noncondensibles portion of cooled condensate Y are condensed. Accordingly, discharge stream Z from vacuum pump 236 contains a liquid portion made up of condensed vapor which includes essence components and a vapor portion, which also contains essence. Discharge stream Z is sent to vapor separator 238. In vapor separator 238, discharge stream Z separates into these two distinct portions; a liquid portion AA and a vapor portion CC.

Vapor separator 238 contains two working sections; an upper section and a lower section. The lower section is an open vessel that separates the liquid portion AA and the vapor portion CC contained in discharge stream Z. The liquid portion AA falls to the bottom of the vessel, where it is re-circulated from the bottom of the vessel through a heat exchanger 240, back into the suction side of vacuum pump 236. Cooling liquid (CL), such as refrigerated glycol or other cooling medium, is used in heat exchanger 240 to cool the re-circulated liquid AA to 0.5 to 10° C.

Vapor portion CC flows upward to enter the top part of separator 238. The top part of separator 238 is a “scrubber” section, which contains packing, or some other type of mass transfer device, that makes the vapor portion CC contact a cold stream of potable water BB. The stream of potable water BB is cooled to 0.5 to 2.5° C. in a heat exchanger 242 before it enters the scrubbing section of separator 238. This stream of cooled potable water BB scrubs (by absorption) almost all the remaining essence components from vapor portion CC before it is discharged from the system through, for example, a vent. Thus, potable water BB, which now contains essence, falls into the lower section of separator 238.

The liquid level rises in the lower section of separator 238 due to vapor contained in cooled condensate Y being compressed and condensed and by the flow of potable water BB into the lower section of the separator 238. This excess liquid is then transferred from the lower section of separator 238 using a simple overflow level control device. This overflow liquid FF then passes to the inlet of pump 244. The discharge of pump 244 is split into two streams: essence product DD and reflux stream EE.

Essence product DD is drawn off at the desired flow rate through a flow regulator or flow metering device 246 at a rate to produce the maximum quality of essence. Preferably, essence product DD is removed at a rate which would equal from about 150 to about 300 fold essence. The fold rate is a comparison of the amount of mash B fed to vessel 230 with the amount of essence product DD produced. Thus, 300 fold would equal one pound of essence for each 300 pounds of mash.

Preferably, reflux flow EE is returned to the top of vessel 230. Typically, reflux flow EE is returned to vessel 230 in the rectification section 230R of vessel 230 (as described below).

Preferably, to increase the concentration of the essence contained in essence product DD, vapor stream T is rectified, using distillation. Distillation allows for the rectification or concentration of the more volatile component of a stream. As shown in FIG. 2, by means of a series of trays (placed horizontally or at an angle), packing or other mass transfer devices and reflux of reflux flow EE back to the rectification section 230R of vessel 230, a high concentration of essence in essence product DD can be obtained.

On flashing of mash B in vessel 230, mash stream U falls to the bottom of vessel 230, where it is removed from vessel 230. Mash stream U is then sent on for further processing. Alternatively, mash stream U is held in vessel 230 to increase the residence time. Preferably, this is achieved by including trays or other mass transfer devices in vessel 230. Although not meaning to be bound by theory, it is believed that by increasing the residence time of mash stream U in vessel 230, any residual essence contained in mash stream U will migrate from the center of each of the particulates of mash stream U and travel upwards with vapor stream U, thereby giving improved essence recovery. It is desirable to hold mash stream U in vessel 230 for from about a few seconds to about 5 minutes, depending on the type of product, with less than one minute being typical.

Further, vessel 230 can be utilized as a “stripping” column. A stripping gas V is provided to the stripping section 230S of vessel 230. As mash B falls through trays in the stripping section 230S of vessel 230, essence is “stripped” from mash B by stripping gas V and flows upwards with the upflow of stripping gas V. Stripping gas V is preferably steam, but may be any useful stripping gas, such as nitrogen or carbon dioxide. Stripping gas V, which is now rich in essence, joins vapor stream T for processing (as described above) to recover the essence.

As shown in FIG. 2, flashing of mash B into vapor stream T and mash stream U and the distillation of vapor stream T can occur in a single vessel, such as vessel 230. Alternatively, as shown in FIG. 3, the flashing and distilling can occur in separate vessels 230B and 230C. For example, mash B is provided to a stripper vessel 230b. Mash B is flashed in stripper vessel 230B to produce a vapor stream T and a mash stream U, where vapor stream T includes the essence.

Preferably, the flashing occurs by providing mash B to stripper vessel 230B at a temperature of from about 40° to about 100° C., with from 85° to 100° C. being especially preferred. Stripper vessel 230B is under vacuum conditions, with a vacuum of from about 20″ Hg to about 28″ Hg being preferred. Accordingly, mash B, when subjected to the vacuum conditions in stripper vessel 230B, will flash to a temperature of from about 37° to about 71° C., thereby releasing a corresponding volume water vapor. Because the essence is highly volatile, the vast majority of the essence will be contained in vapor stream T.

Mash stream U is removed from stripper vessel 230B and sent on to further processing. As discussed above, it is desirable to include a means in stripper vessel 230B to increase the residence time of mash stream U in stripper vessel 230B to allow additional essence to migrate from the center of each of the particulates of mash stream 230B, thereby giving improved essence recovery. Additionally, stripper vessel 230B can be utilized as a stripping column, as discussed above for vessel 230 by providing stripping gas V.

Vapor stream T is provided to a separate vessel for distilling, such as distillation column 230C. Preferably, distillation column 230C is a rectification column, where the essence from vapor stream T is concentrated using steam as the heating medium. As described above, by means of a series of trays, packing or other mass transfer devices and reflux of the essence back to the top of the distillation column, a high concentration of essence can be obtained.

Vapor stream T is condensed as described above and as shown in FIG. 2 to produce a high quality essence product DD.

Thus, the above description describes a method and apparatus for recovering a high quality essence from a mash stream. The particular type of equipment such as, for example, the types and sizes of vessels, piping, and pumps, utilized in the present invention is available processing equipment known to those of ordinary skill in the art.

By use of the present invention, improved quality essence can be obtained. The present invention allows for the recovery of essences before the fruit has undergone significant heat treatment and residence times. Accordingly, the essence has limited opportunity to degrade. Further, because the essence recovery system of the present invention is located prior to the pressing step, essence from the entire fruit product can be recovered. Thus, a essence having a high quality is obtained. In addition, the present invention produces an essence of high quality which contains higher concentrations of the higher alcohols, esters, carbonyls, aldehydes, etc, than essences recovered using prior art methods of recovering essence.

Although the invention has been described in detail for the purpose of illustration, it is understood that such detail is solely for that purpose, and that variation can be made therein by those skilled in the art without departing from the spirit and scope of the invention which is defined by the following claims.

What is claimed:

1. A method of recovering essence from a mash comprising:
providing a mash comprising essence;
treating the mash to produce a vapor stream and a mash stream, wherein the vapor stream comprises the essence; and
condensing the vapor stream under conditions effective to recover the essence.

2. The method according to claim 1, wherein the treating comprises flashing the mash.

3. The method according to claim 2, further comprising:
distilling the vapor stream prior to the condensing.

4. The method according to claim 3, wherein the distilling comprises:
concentrating the essence in the vapor stream using rectification.

5. The method according to claim 4, wherein the treating further comprises:
stripping the essence from the mash stream.

6. The method according to claim 3, wherein the condensing comprises:
cooling the vapor stream to a temperature of from about 0.5° to about 10° C.

7. The method according to claim 6, wherein the condensing comprises:
cooling the vapor stream to a temperature of from about 32° to about 34° C. in a first cooling step and
cooling the vapor to a temperature of from about 0.5° to about 10° C. in a second cooling step.

8. The method according to claim 7, wherein the vapor stream comprises a noncondensibles portion comprising essence and the condensing further comprises:
treating the vapor stream whereby the noncondensibles comprising essence are absorbed and condensed to recover the essence.

9. The method according to claim 3, wherein the flashing and distilling occur in the same vessel.

10. The method according to claim 3, wherein the flashing and distilling occur in different vessels.

11. The method according to claim 9, wherein the mash stream passes through mass transfer devices to increase the residence time of the mash stream in the vessel.

12. The method according to claim 11, wherein the mass transfer devices are trays.

13. The method according to claim 10, wherein the mash stream passes through mass transfer devices to increase the residence time of the mash stream in the vessel.

14. The method according to claim 13, wherein the mass transfer devices are trays.

15. An essence recovery system for recovering essence from a mash comprising essence comprising:
means for treating the mash comprising essence to produce a vapor stream and a mash stream, wherein the vapor stream comprises the essence; and
a condenser for condensing the vapor stream under conditions effective to recover the essence.

16. The essence recovery system according to claim 15, wherein the means for treating comprises a flash vessel.

17. The essence recovery system according to claim 16, further comprising:
a means for distilling the vapor stream.

18. The essence recovery system according to claim 17, wherein the means for distilling comprises:
a rectification column.

19. The essence recovery system according to claim 18, further comprising:
a scrubber system.

20. The essence recovery system according to claim 18, wherein the flash vessel and the rectification column are located in a single vessel.

21. The essence recovery system according to claim 20, wherein the vessel comprises mass transfer devices to increase the residence time of the mash stream in the vessel.

22. The essence recovery system according to claim 21, wherein the mass transfer devices are trays.

23. The essence recovery system according to claim 16, wherein the flash vessel further comprises a means for stripping.
